(19) United States
(12) Patent Application Publication
(10) Pub. No.: US 2014/0140082 A1
(43) Pub. Date: May 22, 2014

(54) LIGHT-EMITTING MODULE

(71) Applicants: Osamu Kuboyama, Shizuoka (JP); Shogo Sugimori, Shizuoka-ken (JP); Hisayoshi Daicho, Shizuoka (JP)

(72) Inventors: Osamu Kuboyama, Shizuoka (JP); Shogo Sugimori, Shizuoka-ken (JP); Hisayoshi Daicho, Shizuoka (JP)

(73) Assignee: KOITO MANUFACTURING CO., LTD., Tokyo (JP)

(21) Appl. No.: 14/129,632

(22) PCT Filed: Jun. 28, 2012
(86) PCT No.: PCT/JP2012/066619

§ 371 Date: Dec. 27, 2013

(30) Foreign Application Priority Data
Jun. 28, 2011 (JP) 2011-142545
May 31, 2012 (JP) 2012-123940

(51) Int. Cl. F21V 9/00; F21S 8/10

(52) U.S. Cl. CPC F21V 9/00; F21S 48/12
USPC 362/510; 362/84

(57) ABSTRACT

A light emitting module has a plurality of light emitting elements that emit ultraviolet radiation or short-wavelength visible light mounted on a support substrate in a predetermined two-dimensional pattern, and a luminescent material having resin that contains at least one or more types of luminescent materials that are excited to emit visible light by the ultraviolet radiation or short-wavelength visible emitted by the light emitting element. The plurality of light emitting elements are connected together into a line by the luminescent material containing resin.

### BACKGROUND

1. Technical Field

The present invention relates to a light emitting module which employs a luminescent material and more particularly to a light emitting module which employs a luminescent material which emits light by being excited by ultraviolet radiation or short-wavelength visible light.

2. Related Art

In recent years, light emitting modules have been widely used which employ a white LED which emits white light by combining a semiconductor light emitting element which emits, for example, blue light, a luminescent material which emits green light by being excited by blue light and a luminescent material which emits red light by being excited by blue light (refer to Patent Literature 1).

Alternatively, a light emitting module is known which can emit high-output and high color rendering white light or light in other colors by combining a light emitting element such as a light emitting diode (LED) which is made up of an InGaN-based compound semiconductor which emits ultraviolet radiation or short-wavelength visible light or a laser diode (LD) and luminescent materials which emit individually blue light and yellow light and the like by being excited by the ultraviolet radiation or short-wavelength visible light which is emitted by the light emitting element. As an example, there is a single light emitting module which is formed by mounting a light emitting element like the one described above on a support substrate and applying a luminescent material containing resin which is formed by mixing the luminescent materials described above into a binder which is in the form of liquid or gel to an upper surface of the light emitting element (refer to Patent Literature 2). In addition, there is a long light emitting module in which a plurality of light emitting elements like the one described above are mounted into a line on a support substrate and a luminescent material containing resin is applied to pot the light emitting elements in such a way as to cover them integrally with the resin, so that the whole of the luminescent material containing resin which is molded into a line is illuminated uniformly (refer to Patent Literature 3).
Patent Literature 1: JP-A-10-107325
Patent Literature 2: JP-A-2009-38348 (Paragraphs 0021 to 0038, FIG. 1)
Patent Literature 3: WO-2010-150459 (Paragraphs 0021 to 0040, FIG. 1)

### SUMMARY

However, in the light emitting module described in Patent Literature 1 in which light emitted from the light emitting element and light emitted from the luminescent materials are combined together, since the balance of colors changes in accordance with a distance from the light emitting element due to the thicknesses of the luminescent materials, it has been difficult to emit light of a uniform color in a line. In addition, due to the recent diversification in design, the long light emitting module described in Patent Literature 3 cannot be used to meet a required shape of illumination in which a line of illumination is formed into a two-dimensional complex pattern. Instead, since a plurality of single light emitting modules like the one described in Patent Literature 2 are combined together to deal with such a requirement, the positioning work of the light emitting modules is troublesome, which increases the production costs accordingly. In addition, when attempting to illuminate a portion which expands round a corner in a three-dimensional fashion, the light emitting modules described in Patent Literatures 1 and 2 which are formed by employing the hard substrates made of ceramics or the like cannot be attached to such a portion, and hence, with those light emitting modules, the required variation of illumination has not been able to be met.

A light emitting module according to one or more embodiments of the present invention deals with a complex pattern of illumination and which realizes a uniform illumination with a high luminous flux even with such a complex pattern of illumination.

According to one or more embodiments of the invention, there is formed a light emitting module including a light emitting element which is mounted on a support substrate and which emits ultraviolet radiation or short-wavelength visible light, and a luminescent material containing resin which contains at least one or more types of luminescent materials which are excited to emit visible light by the ultraviolet radiation or short-wavelength visible light which is emitted by the light emitting element, characterized in that a plurality of light emitting elements like the light emitting element are mounted into a predetermined two-dimensional pattern on the support substrate, and the plurality of light emitting elements are connected together into a line by the luminescent material containing resin.

According to one or more embodiments of the invention, there is provided a light emitting module including a light emitting element which is mounted on a support substrate and which emits ultraviolet radiation or short-wavelength visible light, and a luminescent material containing resin which contains at least one or more types of luminescent materials which are excited to emit visible light by the ultraviolet radiation or short-wavelength visible light which is emitted by the light emitting element, characterized in that the support substrate is a flexible printed circuit board.

According to one or more embodiments of the invention, there is formed a light emitting module including a light emitting element which is mounted on a support substrate and which emits ultraviolet radiation or short-wavelength visible light, and a luminescent material containing resin which contains at least one or more types of luminescent materials which are excited to emit visible light by the ultraviolet radiation or short-wavelength visible light which is emitted by the light emitting element, characterized in that the support substrate is a flexible printed circuit board, and a plurality of light emitting elements like the light emitting element are mounted into a predetermined two-dimensional pattern on the support substrate, and the plurality of light emitting elements are connected together into a line by the luminescent material containing resin.

According to one or more embodiments of the present invention, when the luminescent material containing resin is applied to the light emitting elements mounted on the support substrate (to pot them) by using, for example, a dispenser, an illumination which expands two-dimensionally such as “Z” or “A” or “Δ” or “□” can be formed by program controlling the dispenser to connect the light emitting elements which scatter on a surface of the substrate into a desired pattern of illumination.

According to one or more embodiments of the present invention, by using the flexible printed circuit board (hereinafter, referred to as FTC) as the support substrate which constitutes a wiring member for the light emitting element, since the FPC curves freely together with the luminescent material containing resin, it is possible to realize easily the attachment of the light emitting module to a portion of a vehicle which expands round to follow the shape thereof in a three-dimensional fashion such as a vehicle lamp like, for example, a DRL (Daytime Running Lamp) or a clearance lamp.

According to one or more embodiments of the present invention, a light emitting module according to one or more embodiments of the present invention may be used for an indication lamp or an illumination lamp.

According to one or more embodiments of the present invention, a light emitting module according to one or more embodiments of the present invention may be used for a vehicle lamp.

A light emitting module according to one or more embodiments of the invention allows for an easy formation of a novel pattern of illumination such as a character or a figure in which a line of illumination is formed into a complex pattern in a two-dimensional fashion only by program controlling the dispenser. Additionally, according to one or more embodiments of the present invention, there may be no need to combine the single light emitting modules to form a pattern of illumination which expands two-dimensionally, and hence the production costs can be reduced accordingly.

In a light emitting modules according to one or more embodiments of the invention, since white light is obtained only from light emitted from the luminescent material, allowing the light source light to contribute only to the emission of light from the luminescent material, it is possible to realize the emission of light with high luminous flux and of uniform color even with a complex pattern of illumination.

According to one or more embodiments of the present invention, when the flexible printed circuit board is used for the support substrate, it is possible to form the light emitting module which can curve freely, and therefore, even a three-dimensionally curved portion which has conventionally been difficult to be illuminated can be illuminated easily.

According to one or more embodiments of the present invention, it is possible to provide an indication lamp or an illumination lamp and a vehicle lamp which are illuminated with high luminous flux and uniformly into a novel illumination pattern.

### BRIEF DESCRIPTION OF THE DRAWINGS

FIG. 1 is a plan view of a vehicle which includes a DRL and an HMSL which are made up of light emitting modules according to a first and second embodiment of the invention, respectively.

FIG. 2 is a front view of an HL which includes the DRL which is made up of the light emitting module according to the first embodiment.

FIG. 3 is a perspective view of a DRL unit according to the first embodiment.

FIG. 4 is a vertical sectional view (taken along the line IV-IV in FIG. 3) of the DRL unit of the first embodiment.

FIG. 5 is a perspective view of an HMSL which is made up of a light emitting module according to a second embodiment.

FIG. 6 is a front view of a hazard warning illumination triangle which is made up of a light emitting module according to a third embodiment.

FIG. 7 is a plan view showing a light emitting module according to a fourth embodiment.

FIG. 8 is a plan view showing a light emitting module according to a fifth embodiment.

FIG. 9 is an enlarged sectional view taken along the line X9-X9 in FIG. 8.

FIG. 10 is a plan view showing partially a light emitting module according to a sixth embodiment.

FIG. 11 is a plan view showing partially a light emitting module according to a seventh embodiment.

FIG. 12 is a vertical sectional view showing partially a light emitting module according to an eighth embodiment.

FIG. 13 is an explanatory diagram showing an example in which an FPC and a low-bendable substrate are combined for use.

FIG. 14 is an explanatory diagram showing another example in which the FPC and the low-bendable substrate are combined for use.

### DETAILED DESCRIPTION

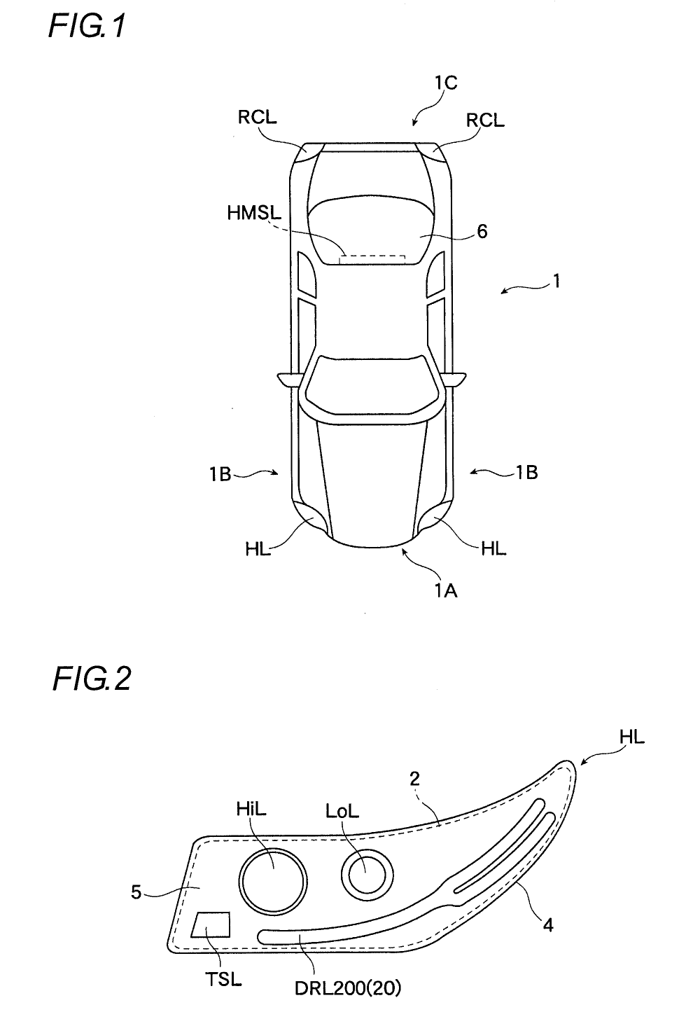

Next, embodiments of the invention will be described with reference to the drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. FIG. 1 is a plan view of a vehicle which includes vehicle lamps such as a DRL and an HMSL which are made up of light emitting modules according to first and second embodiments of the invention, respectively.

Reference numeral 1 denotes a vehicle which is equipped with headlamps (HL) at the left and right of a front portion 1A of a vehicle body and rear combination lamps (RCL) which accommodates a tail lamp, a stop lamp and a turn signal lamp at the left and right of a rear portion 1C of the vehicle body. Then, a daytime running lamp (DRL) 200 which is made up of a light emitting module 20 according to a first embodiment of the invention is accommodated in the HL of the vehicle 1, and an HMSL (High Mount Stop Lamp) 300 which is made up of a light emitting module 30 according to a second embodiment of the invention is provided at an upper end of the center of a rear window 6 of the vehicle 1. Additionally, the front portion 1A of the vehicle body of the vehicle 1 is formed into a complex curved shape in which a central portion of the front portion 1A projects round in every direction.

### Embodiment 1

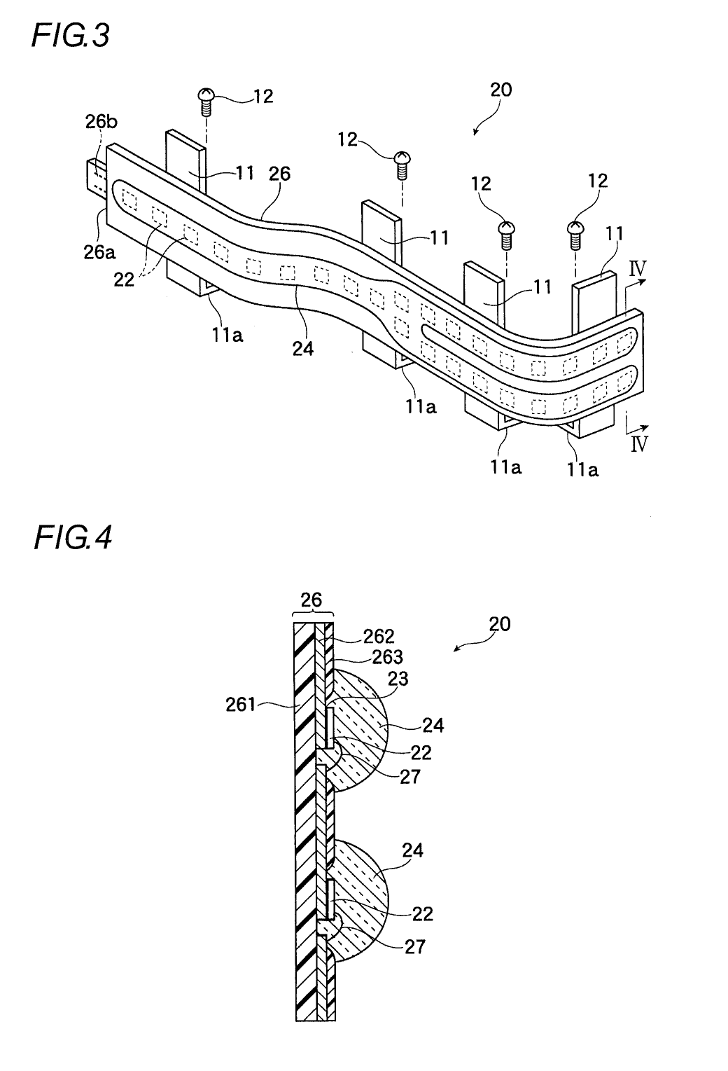

FIG. 2 is a front view of an HL which includes the DRL which is made up of the light emitting module according to a first embodiment, FIG. 3 is a perspective view of a DRL unit of the first embodiment, and FIG. 4 is a vertical sectional view (taken along the line IV-IV in FIG. 3) of the DRL unit of the first embodiment. It is noted that component parts which are accommodated in a lamp compartment and which are visible through a light transmitting cover 4 are indicated by solid lines in FIG. 2.

The HL in FIG. 2 is a lamp which is provided at the right of the vehicle 1 when looking at the vehicle 1 from the front thereof while standing opposite thereto. In this HL, when looking at the HL from the front thereof while standing opposite thereto, a low beam lamp LoL is provided on a right-hand side of a high beam lamp HiL, the high beam lamp HiL is provided on a left-hand side of the low beam lamp LoL, and further, a turn signal lamp TSL is provided side by side on a left-hand side of the high beam lamp HiL in the lamp compartment which is defined by a vessel-shaped lamp body 2 and the light transmitting cover 4. Additionally, a DRL 200 which is made up of a light emitting module 20 is provided in a lower area below the LoL and HiL. An interior of the lamp compartment defined by the lamp body 2 and the light transmitting cover 4 is formed three-dimensional so as to extend round from the front portion 1A of the vehicle body to a side 1B of the vehicle body so that the interior of the lamp compartment follows a streamline shape of the front portion 1A of the vehicle body. The DRL 200 in the interior of the lamp compartment which is so shaped is also disposed to extend in a left-to-right direction in the interior of the lamp compartment so as to follow the curved shape. In addition, these lamps LoL, Hit, DRL 200 are disposed so that their fixing portions and electrical wirings are concealed by an extension 5 which is provided in the interior of the lamp compartment so as not to be visible from the front of the HL.

Next, the light emitting module 20 which makes up the DRL 200 will be described in detail. The light emitting module 20 includes light emitting elements 22, a luminescent material containing resin 24 which contains a yellow luminescent material and a blue luminescent material, and an FPC (flexible printed circuit board) 26.

The light emitting element 22 is an InGaN based compound semiconductor which emits ultraviolet radiation or short-wavelength light having its peak wavelength in a wavelength area of 370 nm to 420 nm, and as an example, a 1-mm square LED chip is adopted which emits light whose center wavelength is about 400 nm. However, the light emitting element 22 is not limited thereto, and for example, a laser diode (LD) may be adopted which emits ultraviolet radiation or short-wavelength visible light.

The FPC 26 constitutes a surface wiring member and a support substrate for the light emitting element 22 and is, as shown in FIG. 4, such that a conductive layer 262 made up of a copper foil or the like is formed into a required electrode pattern on a surface of a horizontally elongate insulation resin film 261 and a surface of the conductive layer 262 is coated with an insulation coating film 263. A feeding terminal 26b is formed at one longitudinal end portion 26a of the FPC 26. This feeding terminal 26b is fitted in a relay connector, not shown, which is provided on the lamp body 2 to thereby be electrically connected. Then, an external power supply feeds the conductive layer 262 from the relay connector via the feeding terminal 26b, and the light emitting elements 22 mounted on the conductive layer 262 are fed in turn. The light emitting elements 22 are soldered on to the FPC 26 (on to portions of the conductive layer 262 which constitute an anode) by using a conductive silver paste 23 and are connected to portions of the conductive layer 262 which constitute a cathode with wires 27 for energization.

The luminescent material containing resin 24 is prepared by mixing together a yellow luminescent material and a blue luminescent material, which will be described later, in a ratio of 2 to 1 by weight and putting the mixture of the luminescent materials in a binder material made up of a silicone resin in the form of liquid or gel in such an amount that the mixture constitutes 1.8 vol % with respect to the binder material for mixing. It is noted that the binder material is not limited thereto and hence that other materials such as a fluorine plastic which has a superior anti-ultraviolet radiation performance may be adopted.

Yellow luminescent materials which absorb near-ultraviolet light or short-wavelength visible light efficiently but absorb almost no visible light whose wavelength is 450 nm or longer are used for the yellow luminescent material. The yellow luminescent material is a luminescent material which changes the wavelength of ultraviolet radiation or short-wavelength light to emit yellow light, and luminescent materials which emit light whose dominant wavelength is in the range of 564 nm or longer to 582 nm or shorter are used. In the first embodiment, as the yellow luminescent material, a luminescent material which is expressed by SiO₂.1.0 (Ca_{0.54}, Sr_{0.36}, Eu_{0.1}) O.0.17 SrCl₂ is used. The yellow luminescent material is a luminescent material in which cristobalite is generated in the luminescent material by adding SiO₂ excessively in terms of a mixing ratio of materials.

In producing the yellow luminescent material, firstly, materials of SiO₂, Ca(OH)₂, SrCl₂.6H₂O and Eu₂O₃ are weighed individually so as to realize a molar ratio of SiO₂:Ca(OH)₂:SrCl₂.6H₂O:Eu₂O₃=1.1:0.45:1.0:0.13. Then, the individual materials weighed are put in an alumina mortar to be ground and mixed together for about 30 minutes, and the mixture is then put in an alumina crucible to be calcined in an electric oven of a reducing atmosphere at 1030° C. for 5 to 40 hours in an atmosphere having an H₂/N₂ ratio of 5 to 95, a calcined product being thereby obtained. Then, the calcined product so obtained is washed carefully with warm pure water, whereby a yellow luminescent material is obtained.

It is noted that the materials of which the yellow luminescent material is formed are not limited to the materials described above. Other materials may be adopted which are expressed by a general formula of M¹O₂.a(M²_{1-z}, M⁴_{z})O.bM³X₂. However, M¹ denotes at least one element which is selected from a group of Si, Ge, Ti, Zr and Sn. M² denotes at least one element which is selected from a group of Mg, Ca, Sr, Ba and Zn. M³ denotes at least one element which is selected from a group of Mg, Ca, Sr, Ba and Zn. X denotes at least one kind of halogen element, and M⁴ denotes at least one element selected from a group of rare earth elements and Mn in which Eu²⁺ is essential. a is in the range of b is in the range of 0.1≦a≦1.3, b is in the range of 0.1≦b≦0.25, and z is in the range of 0.03≦z≦0.8. In this general formula, the yellow luminescent material adopted in the first embodiment is such that M¹=Si, M²=Ca/Sr (a molar ratio of 60/40), M³═Sr, X═Cl, M⁴=Eu²⁺, a=0.9, b=0.17, and the contents c of M⁴ (in a molar ratio) becomes c/(a+c)=0.1.

The blue luminescent material is a blue luminescent material which changes the wavelength of ultraviolet radiation or short-wavelength light to emit blue light. Blue luminescent materials which absorb near-ultraviolet light or short-wavelength visible light efficiently but absorb almost no visible light whose dominant wavelength is 440 nm or longer and 470 nm or shorter are used for the blue luminescent material. In the first embodiment, as the blue luminescent material, a luminescent material which is expressed by (Ca_{4.67}Mg_{0.5}) (PO₄)₃Cl:Eu_{0.08} is used. It is noted that the blue luminescent material is not limited thereto, and hence, a luminescent material to be used for the blue luminescent material may be selected from a group of luminescent materials which are expressed by the following general formulae.

A general formula of M¹a (M²O₄)_{b}X_{c}:Re_{d}M¹ denotes a luminescent material in which one or more kinds of elements of Ca, Sr, Ba are essential and elements of which can partially be replaced with elements selected from a group of Mg, Zn, Cd, K, Ag, Ti. P is essential to M², and M² can partially be replaced with an element selected from a group of V, Si, As, Mn, Co, Cr, Mo, W, B. X denotes at least one kind of halogen element, and Re denotes at least one kind of rare earth element to which Eu²⁺ is essential or Mn. In addition, a is in the range of 4.2≦a≦5.8, b is in the range of 2.5≦b≦3.5, c is in the range of 0.8≦c≦1.4, and d is in the range of 0.01≦c≦0.1.

A general formula of M¹₁₋ₐMgAl₁₀O₁₇:Eu²⁺ₐM¹ denotes a luminescent material in which at least one kind of element selected from a group of Ca, Sr, Ba, Zn is essential, and a is in the range of 0.001≦a≦0.5.

A general formula of M¹₁₋ₐMgSi₂O₈:Eu²⁺ₐM¹ denotes a luminescent material in which at least one kind of element selected from the group of Ca, Sr, Ba, Zn is essential, and a is in the range of 0.001≦a≦0.8.

A general formula of M¹₂₋ₐ(B₅O₉)X:ReₐM¹ denotes a luminescent material in which at least one kind of element selected from the group of Ca, Sr, Ba, Zn is essential, X denotes at least one kind of halogen element, and a is in the range of 0.001≦a≦0.5.

In addition, the light emitting module 20 is formed as follows. Firstly, the light emitting elements 22 are mounted at predetermined intervals into a straight line from a side of the FPC 26 which faces the front portion 1A of the vehicle body towards a side thereof which faces the side 1B of the vehicle body. Then, the light emitting elements 22 are mounted so as to branch into two rows in parallel towards the side 1B of the vehicle body at a portion of the FPC 26 which faces a portion of the vehicle body which extends round towards the side 1B of the vehicle body. Consequently, the light emitting elements 22 are mounted into a two-dimensional shape which branches into the two rows on a surface of the FPC 26. Next, a paste of the luminescent material containing resin 24 which contains the yellow luminescent material and the blue luminescent material is applied to the light emitting elements 22 of the mounted light emitting elements 22 which are mounted from the straight line portion to the divided upper branch portion so as to cover (to pot) them integrally with a dispenser which is a syringe of 10 cc (with a discharging bore diameter φ of 1 mm) by moving the dispenser at a speed of about 10 mm/sec. Then, the discharging of the paste is stopped temporarily, and the dispenser is moved back to the branch point. Following this, the dispenser is moved at the aforesaid speed to cover (to pot) integrally the light emitting elements 22 mounted on the divided lower branch portion. Consequently, the individual light emitting elements 22 are connected together into lines by the paste of the luminescent material containing resin 24 while being sealed in by the luminescent material containing resin 24 which is molded into semi-spherical (dome) shapes of a substantially equal volume which each have a semi-circular section. Finally, the luminescent material containing resin 24 is subjected to a heating treatment in which 150° C. is maintained for one hour while holding the dome shape to set. Thus, the light emitting module 20 is formed which has the two-dimensional light emitting shape in which the light emitting lines branch from the side facing the front portion 1A of the vehicle body to the side facing the side 1B of the vehicle body. In addition, the luminescent material containing resin 24 exhibits an extensibility of about 300% when it sets and hence has flexibility.

Then, as shown in FIG. 3, fixing plates 11 which include a support piece portion 11a formed by bending a lower end portion into an L-shape and which are made up of an aluminum plate having heat dissipating properties are disposed transversely at required locations in the interior of the lamp compartment so as to follow a desired streamline shape. Then, a rear surface of the light emitting module 20 is bonded to the fixing plates 11 while curving the light emitting module 20 so as to follow the streamline shape, and the support piece portions 11a are fixed to a lower surface of the lamp body 2 with screws 12, whereby the light emitting module 20 is mounted easily in the interior of the lamp compartment which is shaped so as to extend round three-dimensionally to follow the shape of the vehicle.

According to first embodiment, by illuminating the light emitting elements 22, light emitted from the yellow luminescent material and the blue luminescent material which scatter in the luminescent material containing resin 24 is added to each other and mixed together, whereby the whole of the luminescent material containing resin 24 is illuminated white uniformly with high luminous flux to form a two-dimensional illumination which branches into two illumination lines from the side facing the front portion 1A of the vehicle body to the side facing the side 1B of the vehicle body.

Further, the conventional approach of positioning the plurality of single light emitting modules is no more necessary to obtain the illumination pattern in which the lines of illumination extend two-dimensionally in a complex fashion. Instead, the dispenser only has to be program controlled so as to apply the luminescent material containing resin 24 into a desired illumination pattern (on to the light emitting elements 22) to thereby form a desired illumination, and this reduces the production costs.

In addition, in the light emitting module 20, the support substrate which constitutes the wiring member for the light emitting elements 22 is made up of the FPC 26 which has the flexibility, and on top of that, the luminescent material containing resin 24 also has the flexibility when it sets. Therefore, the luminescent material containing resin 24 and the FPC 26 can be curved freely together so as to take the same shape as the complex three-dimensional streamline configuration of the front portion 1A of the vehicle body. Consequently, by using the light emitting module 20 which can be curved freely, illumination can easily be formed even at the three-dimensionally curved location in the interior of the lamp compartment of the vehicle 1, which has been difficult to be accomplished by laying out the conventional light emitting module which is formed by using the hard support substrate such as ceramics.

Further, in the light emitting module described in Patent Literature 1 in which light of the light emitting element and light of the luminescent material are combined, since the balance of colors changes in accordance with the distance from the light emitting element due to the thickness of the luminescent material, it has been difficult to emit light of a uniform color in a line. However, in the light emitting module 20, white light is obtained only by light emitted from the yellow luminescent material and the blue luminescent material, and the light source light only contributes to the emission of light from the yellow luminescent material and the blue luminescent material. Therefore, even with the complex illumination pattern of the first embodiment, it is possible to obtain illumination of uniform color and with high luminous flux.

### Embodiment 2

FIG. 5 is a perspective view of an HMSL made up of a light emitting module according to a second embodiment. It is noted that in FIG. 5 component parts which are visible through a light transmitting cover 34 are indicated by solid lines.

An HMSL 300 in FIG. 5 includes a vessel-shaped case 32, a transparent light transmitting cover 34 and a light emitting module 30 according to the second embodiment which is provided in an interior of a lamp compartment which is defined by the case 32 and the light transmitting cover 34. The HMSL 300 is fixed to an upper end of a central portion of an inner side of a rear window 6 via the case 32 by using a known method which uses bolts and nuts.

The light emitting module 30 includes light emitting elements 22 and a luminescent material containing resin 24 containing a yellow luminescent material and a blue luminescent material which are both similar to those of the first embodiment, and an aluminum nitride plate having a rectangular plate-like shape on which an electrode pattern is formed by gold deposition as an example is adopted for a support substrate 36. Then, the light emitting elements 22 are mounted into individual character patterns of “S,” “T,” “O,” and “P” on the support substrate 36 (on the electrode pattern) using a similar method to that used in the first embodiment. As with the first embodiment, the luminescent material containing resin 24 is applied on to the light emitting elements 22 which are mounted into the individual character patterns of “S,” “T,” “O,” and “P” so as to pot them by program controlling a dispenser. Then, a support piece portion 36a of the support substrate 36 which is formed by bending a lower end portion thereof into an L-shape is fixed to a lower surface of the case 32 with screws, whereby the light emitting module 30 is mounted in the interior of the lamp compartment.

It is noted that a tail lamp, a stop lamp, a turn signal lamp and a backup lamp in a RCL of the vehicle 1 are electrically connected to a battery (not shown) of the vehicle 1 by a group of individual switches, and when any one of the switches is on, the lamp corresponding to the switch is illuminated. In the HMSL 300, a control circuit, not shown, which is provided within the case 32 is electrically connected to a battery side wiring harness (not shown) of the vehicle 1 via a wiring harness 33 with a connector, whereby when in the group of RCL switches, the switch for the stop lamp is on, an electric current is allowed to flow to the control circuit to illuminate the light emitting elements 22. Namely, the HMSL 300 is interlocked with the stop lamp of the RCL to be illuminated, and thereby the light emitting module 30 emits white light uniformly and with high luminous flux into a character pattern of “STOP.”

As the light emitting module 30, a light emitting module may, of course, be adopted in which in place of the yellow luminescent material and the blue luminescent material of Embodiment 1, a red luminescent material which changes the wavelength of near-ultraviolet radiation or short-wavelength visible light to emit red visible light and which is expressed by (Ca_{1-x-y}Srₓ) AlSiN₃:Eu²⁺_{y} (where, x is in the range of 0≦x≦992, and y is in the range of 0.001≦y≦0.015) is mixed into the luminescent material containing resin 24. It is noted that the red luminescent material is not limited thereto, and hence, any luminescent material can be adopted as long as the luminescent material emits red light whose peak wavelength is in the range of 660 nm or longer to 800 nm or shorter.

According to the second embodiment, a novel illumination pattern which expands two-dimensionally can easily be formed in the HMSL which is generally given a conventional illumination pattern in which a plurality of LEDs which emit visible light are aligned into a straight line (one-dimensionally). In addition, it is possible to emit light with higher luminous flux and more uniformly than a conventional HMSL, and therefore, the HMSL can be provided which has superior visibility from the following vehicle.

It is noted that the light emitting module 30 can be formed not only into the pattern of “STOP” but also into various patterns of characters and figures for illumination. Consequently, it is possible to form easily a vehicle lamp which is interlocked with the turn signal lamp of the RCL so as to be illuminated when the turn signal lamp is illuminated by forming a light emitting module in which the light emitting elements 22 are aligned into patterns of, for example, “right” or “left” and are then connected together in a line with the luminescent material containing resin 24.

In addition, in the second embodiment, too, by using an FPC for the support substrate 36, even though the rear window 6 is curved as a specification of the vehicle 1, since the light emitting module 30 can be curved freely along the rear window 6, the light emitting module 30 can easily be laid out.

### Embodiment 3

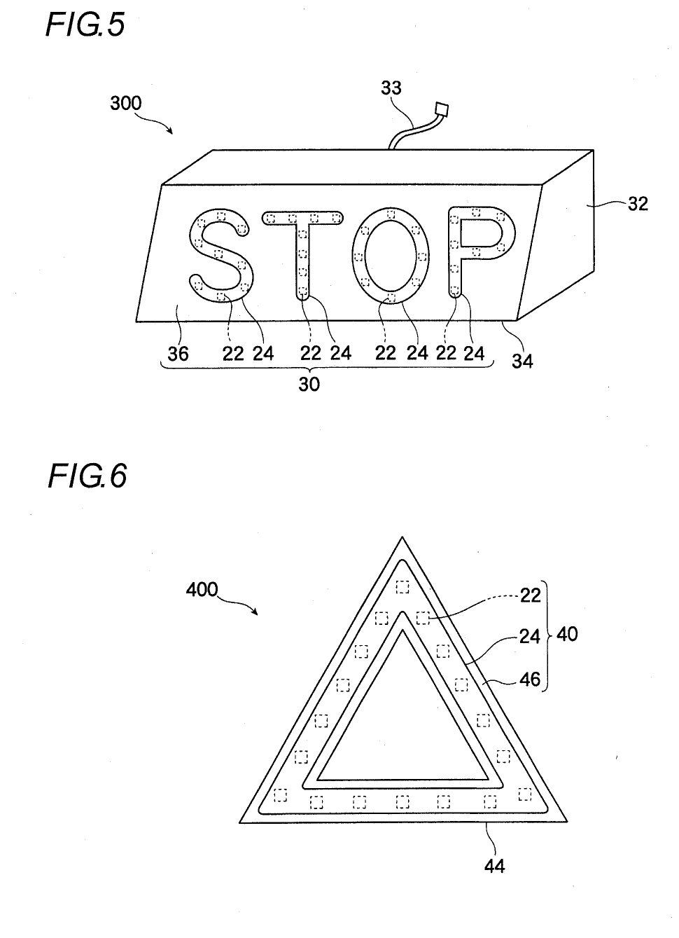

FIG. 6 is a front view of a hazard warning illumination triangle which is made up of a light emitting module according to a third embodiment. It is noted that component parts which are visible through a light transmitting cover 44 are indicated by solid lines.

A hazard warning illumination triangle 400 shown in FIG. 6 is a triangular framed device which is used when the vehicle 1 is stopped for an emergency reason and includes a light emitting module 40 according to the third embodiment in which a triangular framed aluminum nitride plate on a surface of which an electrode pattern is formed by using a gold deposition method, as an example, which is similar to that of the second embodiment and the remainder of the surface of which is mirror finished is used for a support substrate 46 and a triangular frame shaped transparent light transmitting cover 44 which protects a front surface of the light emitting module 40. In the light emitting module 40, in place of the yellow luminescent material and the blue luminescent material of Embodiment 1, a red luminescent material which changes the wavelength of near-ultraviolet radiation or short-wavelength visible light to emit red visible light and which is expressed by (Ca_{1-x-y}Srₓ)AlSiN₃:Eu²⁺_{y} (where, x is in the range of 0≦x≦0.992, and y is in the range of 0.001≦y≦0.015) is mixed into the luminescent material containing resin 24. It is noted that the red luminescent material is not limited thereto, and hence, any luminescent material can be adopted as long as the luminescent material emits red light whose peak wavelength is in the range of 660 nm or longer to 800 nm or shorter.

Then, in the light emitting module 40, light emitting elements 22 which are the same as those of Embodiment 1 are mounted on the support substrate 46 in a triangular pattern by using the same method as that of Embodiment 1, and the luminescent material containing resin 24 which contains the red luminescent material is applied on to the light emitting elements 22 in such a way as to follow the pattern of triangle or “Δ” so as to cover (to pot) the light emitting elements 22.

With this hazard warning illumination triangle 400 made to be fed from a predetermined external power supply provided on a rear surface of the support substrate 46 or mounted on a rear surface of a trunk lid of the vehicle 1 so as to be fed from the battery of the vehicle, the light emitting elements 22 are illuminated, and (the luminescent material containing resin 24 of) the light emitting module 40 emits red light into the pattern of “Δ” uniformly and with high luminous flux. According to the third embodiment, since the light emitting module 40 can emit light with higher luminous flux and more uniformly than a conventional hazard warning reflective triangle which uses red reflection plates, it is possible to provide the hazard warning illumination triangle which has superior visibility.

It is noted that the shape of the light emitting module 40 is not limited to “Δ” and hence, illumination of various patterns of characters or figures can be formed only by changing the setting of the dispenser. Consequently, for example, a light emitting module having a pattern of “□” is formed by aligning the light emitting elements 22 into that pattern and connecting them together in a line by the luminescent material containing resin 24, whereby an indication lamp or an illumination lamp which is placed along a road can easily be formed.

Additionally, in the light emitting modules 30, 40 of the second and third embodiments, a vehicle lamp or an indication lamp which emits white light may, of course, be configured by using the yellow luminescent material and the blue luminescent material of the first embodiment.

In addition, in the DRL 200 of the first embodiment and the HMSL 300 of the second embodiment, in the event that the red luminescent material is additionally mixed into the luminescent material containing resin 24 which contains the yellow luminescent material and the blue luminescent material, the red wavelength range is supplemented, whereby it is possible to provide a vehicle lamp or an indication lamp which can emit white light having color rendering properties.

### Embodiment 4

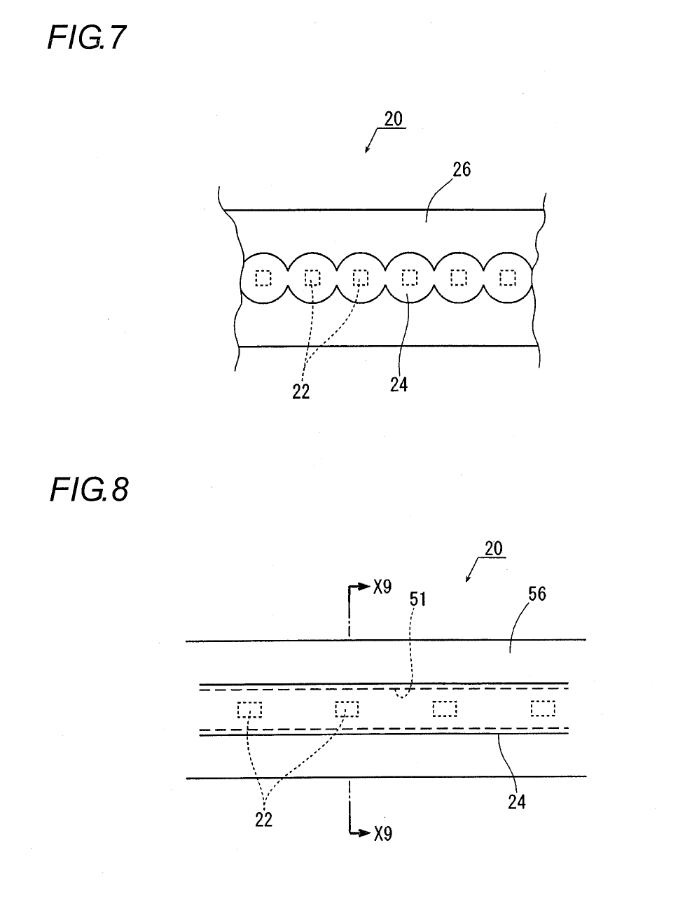

A fourth embodiment describes a configuration in which a liner light source is formed by forming a luminescent material containing resin 24 into a series of continuous dome-like lens shapes as shown in FIG. 7. It is noted that in the following embodiments (including this fourth embodiment and embodiments that follow), like reference numerals will be given to like constituent elements to those of the above embodiments (the first to third embodiments), and the description thereof will be omitted.

In the DRL 200, in order to make its light distribution pattern comply with standards prescribed under SAE J2087 AUG91, ECE 87 and the like, in many cases, lenses and/or reflection mirrors are used. However, the inventor discovered that the luminescent material containing resin 24 can be discharged into a lens-like shape to pot a light emitting element by controlling the viscosity of the luminescent material containing resin 24 to 1 to 500 Pa·s, an application pressure which is applied to an interior of the syringe in applying the luminescent material containing resin 24 (to pot the light emitting element) to 1 kPa to 50 kPa, a discharge bore diameter of the syringe to 0.1 to 2.5 mm, and a dispenser nozzle moving speed to 0 to 100 mm/s More specifically, after the viscosity of the luminescent material containing resin 24 is controlled to 100 Pa·s, the application pressure applied to the interior of the syringe in applying the luminescent material containing resin 24 (to pot the light emitting element) to 50 kPa, and the discharge bore diameter of the syringe to 1.43 mm, the luminescent material containing resin 24 is applied at a dispenser nozzle moving speed of 0 mm/s (with the dispenser nozzle stopped). After the application of the luminescent material containing resin 24 is completed, the dispenser nozzle is moved about 8 mm, so that the luminescent material containing resin 24 is applied to the position where the dispenser nozzle has been so moved. By repeating this series of operations, a linear light source having a series of continuous dome-like lens shapes is obtained. Since this linear light source has a lens function, in the case of the linear light source being used as a light source for the DRL 200, the necessity of lenses other than the light emitting module can be obviated or reduced largely, whereby the production costs can be reduced.

### Embodiment 5

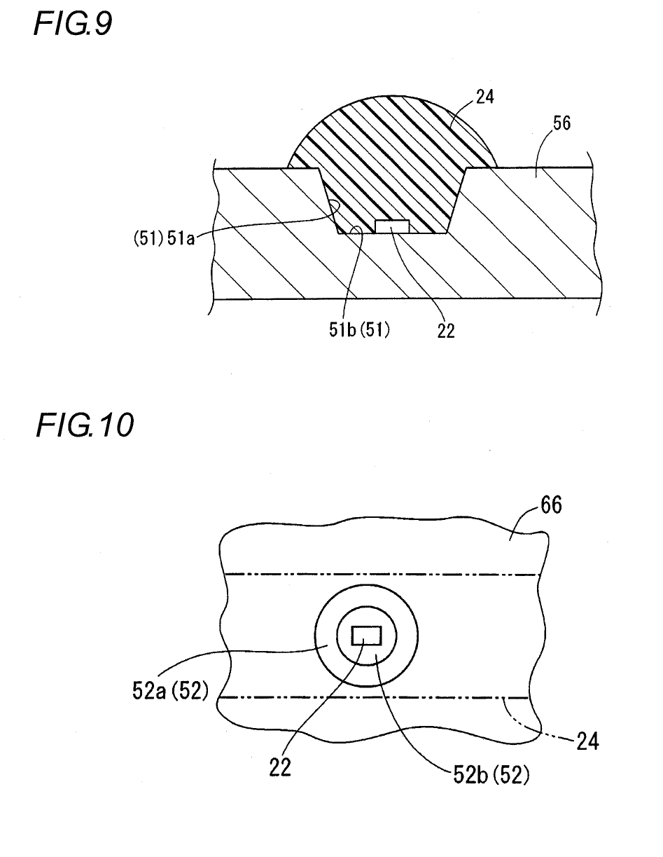

As shown in FIGS. 8, 9, a fifth embodiment describes a configuration in which reflection mirrors are formed on a support substrate 56 made up of an aluminum plate or the like.

In this fifth embodiment, grooves 51 are formed in a surface of the support substrate 56 (refer to FIG. 9). Inner surfaces 51a of both side walls of each of the grooves 51 are inclined so as to be spaced more apart from each other as they extend from a bottom surface 51b towards an opening. Light emitting elements 22 are mounted (disposed) on the bottom surfaces 51b of the grooves 51, whereby the light emitting elements 22 are disposed at predetermined intervals on the support substrate 56. Then, a luminescent material containing resin 24 is applied to interiors of the grooves 51 and the light emitting elements 22, whereby the luminescent material containing resin 24 is formed into an arc-like shape on each of the grooves 51 of the support substrate 56. This allows the inner surfaces 51a of both the side walls of the grooves 51 to have a light distribution control function by a reflection mirror. In the case of this linear light source being used for a DRL 200, the necessity of reflection mirrors other than a light emitting module 20 can be obviated or reduced largely, whereby the production costs can be reduced.

### Embodiment 6

A sixth embodiment describes a modified example made to the fifth embodiment.

In this sixth embodiment, as shown in FIG. 10, recess portions 52 are formed individually in a support substrate 66 which is made up of an aluminum substrate or the like in positions where light emitting elements 22 are disposed, and light emitting elements 22 are disposed on respective bottom surfaces 52b of the recess portions 52. In this case, an opening of each recess portion 52 is formed into a circular shape when seen from the top thereof, and the recess portion 52 is reduced gradually in diameter as it extends inwards in a thickness direction of the support substrate 66, whereby an inner circumferential surface 52a of the recess portion 52 has a function as a reflection mirror based on the construction of the recess portion 52 in which the diameter thereof is so reduced.

### Embodiment 7

A seventh embodiment describes a modified example made to the sixth embodiment.

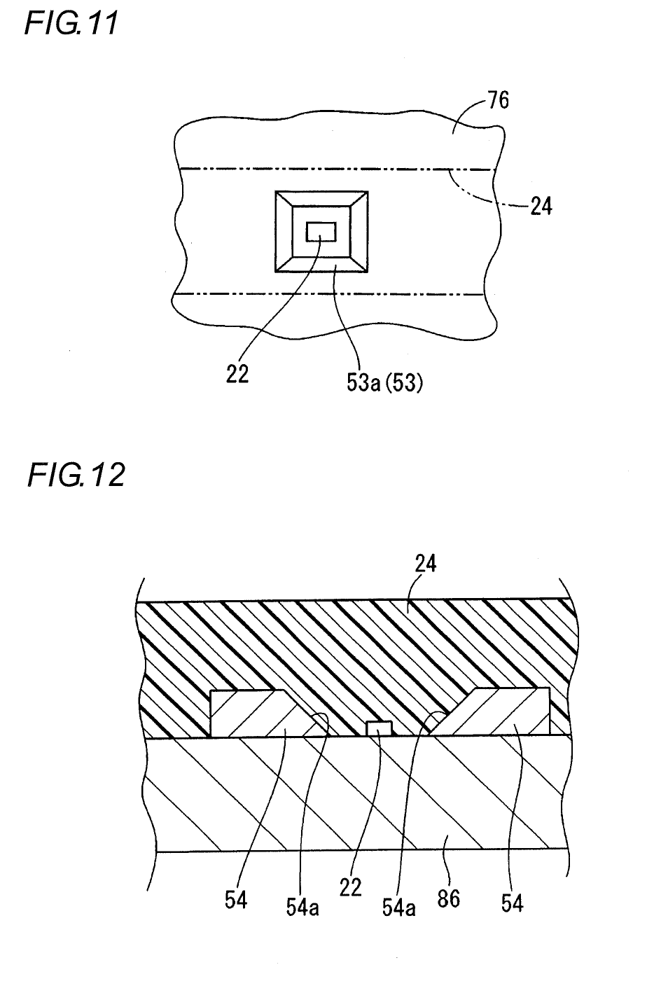

In the seventh embodiment, as shown in FIG. 11, recess portions 53 are each formed to a support substrate 76 which is made up of an aluminum substrate or the like into a quadrangular shape, and with respect to oppositely facing inner surfaces of inner surfaces 53a which extend downwards from sides of an opening in each recess portion 53, the inner surfaces 53a are inclined so as to approach each other as they extend downwards from the sides of the opening of the recess portion 53. By adopting this configuration, in the seventh embodiment, the inner surfaces 53a which extend downwards from the sides of the opening in each recess portion 53 have a function as a reflection mirror.

### Embodiment 8

An eighth embodiment describes a modified example made to the fifth embodiment.

In the eighth embodiment, as shown in FIG. 12, pairs of rising portions 54 are provided on a support substrate 86. Each pair of rising portions 54 are disposed so as to form a groove therebetween, and light emitting elements 22 are disposed on the support substrate 86 so as to lie between the pairs of rising portions 54. Inner surfaces 54a of each pair of rising portions 54 are inclined so as to be spaced more apart from each other as they extend outwards in a thickness direction of the support substrate 86, and these inclined inner surfaces 54a have a function as a reflection mirror based on the material (aluminum or the like) of the rising portions 54.

In this case, in place of the configuration in which the pairs of rising portions 54 are provided to form the grooves therebetween, a configuration may be adopted in which recess portions are formed individually for the light emitting elements 22 by rising portions 54, so that the light emitting elements 22 are disposed individually within the recess portions so formed.

Thus, while the embodiments of the invention have been described above, the scope of the invention is not limited thereto. For example, the scope of the invention includes the following variations.

(1) With respect to the method of forming the luminescent material containing resin (film) 24, the invention is not limited to the method of applying the luminescent material containing resin 24 by using the dispenser, and hence, other forming methods such as injection molding, compression molding or the like may be used.

(2) In the first embodiment, while the FPC 26 is formed of resin such as epoxy resin or the like or metal such as aluminum, copper or the like in many cases, other materials may be used.

(3) Depending upon the shape of the DRL 200, other materials than the FPC 26 may be used which includes a thick epoxy-glass substrate, metal substrate of aluminum, copper or the like, ceramic substrate and the like which have low flexing properties.

(4) For the sake of ensuring the flexibility, the FPC 26 and any of the substrates having the low flexing properties which are described under (3) above are combined for use.

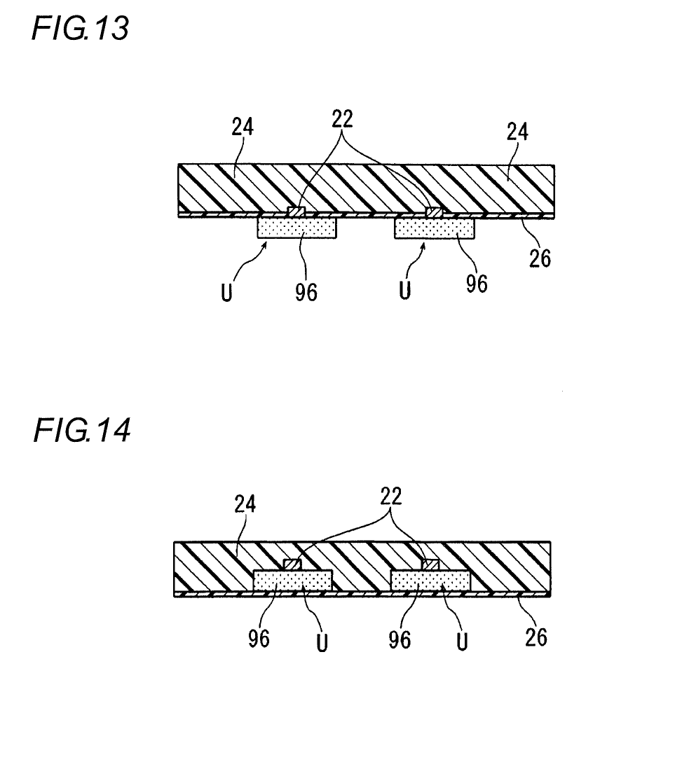

Specifically, as shown in FIGS. 13, 14, units U are prepared in which a light emitting element 22 is mounted on a substrate 96 having low flexing properties, and the units U are mounted on the FPC 26 at intervals according to one or more embodiments of the present invention. Namely, as shown in FIG. 13, a configuration may be adopted in which the substrates (the substrates having low flexing properties) 96 of the units U are attached to one of surfaces of the FPC 26 (a lower surface in FIG. 13), while the light emitting elements 22 are caused to penetrate the FPC 26 to project from the other surface of the FPC 26 (an upper surface in FIG. 13), and the light emitting elements 22 are covered by a luminescent material containing resin 24. Alternatively, as shown in FIG. 14, a configuration may be adopted in which the units U in which the light emitting element 22 is mounted on the substrate 96 having the low flexing properties are attached to the other surface of the FPC 26 (an upper surface in FIG. 14), and the units U are covered by the luminescent material containing resin 24.

(5) The output luminous flux of the light emitting module 20 should be of the order of 200 to 1200 lm to satisfy the SAE standard (SAE J2087 AUG91) and the ECE standard (ECE R87).

Because of this, in the light emitting module 20, an electric current of 500 to 3000 mA should flow to the plurality of light emitting elements 22 in order to obtain the output luminous flux described above.

(6) An appropriate interval at which a plurality of light emitting elements 22 are mounted is changed based on the value of an electric current caused to flow to each light emitting element 22.

Specifically, according to one or more embodiments of the present invention, the relationship between the interval defined between the light emitting elements 22 and the value of an optimum electric current caused to flow to each light emitting element 22 should be as follows:

10 to 30 mA at an interval of 0.5 to 5 mm;

20 to 300 mA at an interval of 3 to 20 mm;

100 to 1000 mA at an interval of 10 to 50 mm; and

300 to 1500 mA at an interval of 30 to 100 mm.

More specifically, according to one or more embodiments of the present invention, when the value of an electric current caused to flow to the light emitting element 22 is 100 mA, the interval defined between the light emitting elements 22 is 8 mm. When the plurality of light emitting elements 22 are disposed at wider intervals than the appropriate intervals described above, bright portions and dark portions are generated in the light emitting module 20, and hence, light emitted therefrom does not become uniform in intensity, while the light emitting elements 22 are disposed at narrower intervals than the appropriate intervals described above, the number of light emitting elements 22 provided is increased unnecessarily, thereby increasing the production costs.

(7) When various lengths are required for the DRL 200 (the light emitting module 20) to satisfy various designs, while satisfying the conditions on luminous flux (refer to Item (5)), light emitting modules 20 of various lengths can be realized by changing the intervals at which a plurality of light emitting elements 22 are mounted and the value of an electric current caused to flow to each light emitting module 22.

Specifically, according to one or more embodiments of the present invention, the relationship between the interval defined between the light emitting elements 22 and the value of an optimum electric current caused to flow to each light emitting element 22, and the length of the light emitting module 20 for the DRL 200 are as follows:

when the interval defined between the light emitting elements 22 is 0.5 to 5 mm and the value of an optimum electric current caused to flow to each emitting element 22 is 10 to 30 mA, the length of the light emitting module 20 should be 8 to 1500 mm;

when the interval defined between the light emitting elements 22 is 3 to 20 mm and the value of an optimum electric current caused to flow to each emitting element 22 is 20 to 300 mA, the length of the light emitting module 20 should be 3 to 3000 mm;

when the interval defined between the light emitting elements 22 is 10 to 50 mm and the value of an optimum electric current caused to flow to each emitting element 22 is 100 to 1000 mA, the length of the light emitting module 20 should be 10 to 1500 mm; and

when the interval defined between the light emitting elements 22 is 30 to 100 mm and the value of an optimum electric current caused to flow to each emitting element 22 is 300 to 1500 mA, the length of the light emitting module 20 should be 30 to 1000 mm.

By adopting the aforesaid relationships, various lengths can freely be realized for the DRL 200 which can deal with a wide variety of designs.

As a more specific example, when the light emitting module 20 for the DRL 200 requires a luminous flux of 200 lm and a length of 200 mm, the requirements can be realized by setting so that the interval at which the light emitting elements 22 are mounted is 8.3 mm, the value of an electric current caused to each light emitting element 22 is 40 mA, and 24 light emitting elements 22 are mounted.

(8) An appropriate value for the width of the luminescent material containing resin 24 which is applied into the semi-spherical shape (the dome-like shape) having the semicircular section should be the width of the light emitting element 22 to 20 mm, and an appropriate value for the height of the luminescent material containing resin 24 so applied should be 0.5 to 3 times the application width thereof.

When the width and height of the luminescent material containing resin 24 are larger than those appropriate values, the efficiency with which light generated inside the luminescent material containing resin 24 is emitted to the outside thereof is reduced, as a result of which the efficiency of the light emitting module 20 is reduced. On the other hand, when the application width and the application height are smaller than those appropriate values, it becomes difficult to cover the light emitting elements 22 completely, as a result of which it becomes difficult to produce the light emitting module 20.

(9) The method of fixing the light emitting module 20 to the fixing plates 11 is not limited to bonding, and hence, other methods such as screwing, crimping, fastening by other component parts or the like should be used.

(10) Other materials than aluminum such as iron, copper, ceramic and the like should be used as the fixing plates 11.

(11) A heat transmitting member such as a heat pipe, a water cooling unit, a Peltier element and the like should be provided on the fixing plates 11 to increase the heat dissipating performance thereof.

(12) A chip-on-board form should be adopted in which the light emitting element 22 is mounted directly on the fixing plate 11 and the light emitting element 22 so mounted is sealed in by the luminescent material containing resin 24.

By adopting this form, the substrate such as the FTC 26 becomes unnecessary, thereby making it possible to reduce the production costs.

(13) As a driving voltage of the DRL 200, the battery voltages of the vehicle such as 12V and 24V or a desired voltage to which the battery voltages of the vehicle are changed by a DC-DC converter should be used.

As this occurs, the wiring of the light emitting elements 22 should be based on a series connection in which the number of wirings is equal to or smaller than [the driving voltage÷ the voltage of the light emitting element 22].

In addition, since a current limit is necessary, when a DC-DC converter having a current limiting function is not used, a current limiting power supply circuit should be used separately which includes a resistance, a transistor, an FET, a constant-current diode and the like.

While the invention has been described in detail and by reference to the specific embodiments, it is obvious to those skilled in the art to which the invention pertains that various alterations and/or modifications can be made thereto without departing from the spirit and scope of the invention.

This patent application is based on Japanese Patent Application No. 2011-142545 filed on Jun. 28, 2011 and Japanese Patent Application No. 2012-123940 filed on May 31, 2012, the contents of which are incorporated herein by reference.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF REFERENCE NUMERALS

20, 30, 40: light emitting module; 22: light emitting element; 24: luminescent material containing resin; 26 FPC which is a substrate; 36, 46, 56, 66, 76, 86: support substrate; 200: DRL which is a vehicle lamp; 300: HMSL which is a vehicle lamp; 400: hazard warning illumination triangle which is a warning indication lamp.

1. A light emitting module comprising:
a plurality of light emitting elements that emit ultraviolet radiation or short-wavelength visible light mounted on a support substrate in a predetermined two-dimensional pattern; and
a luminescent material comprising resin that contains at least one or more types of luminescent materials that are excited to emit visible light by the ultraviolet radiation or short-wavelength visible emitted by the light emitting element,
wherein the plurality of light emitting elements are connected together into a line by the luminescent material containing resin.

2. A light emitting module comprising:
a light emitting element that emits ultraviolet radiation or short-wavelength visible light mounted on a support substrate; and
a luminescent material comprising resin that contains at least one or more types of luminescent materials that are excited to emit visible light by the ultraviolet radiation or short-wavelength visible emitted by the light emitting element,
wherein the support substrate is a flexible printed circuit board.

3. The light emitting module of claim 1,
wherein the support substrate is a flexible printed circuit board.

4. An indication lamp comprising:
the light emitting module of claim 1.

5. A vehicle lamp comprising:
the light emitting module of claim 1.

6. An indication lamp comprising:
the light emitting module of claim 2.

7. An indication lamp comprising:
the light emitting module of claim 3.

8. An illumination lamp comprising:
the light emitting module of claim 2.

9. An illumination lamp comprising:
the light emitting module of claim 3.

10. A vehicle lamp comprising:
the light emitting module of claim 2.

11. A vehicle lamp comprising:
the light emitting module of claim 3.
